(19) United States
(12) Patent Application Publication
(10) Pub. No.: US 2009/0235994 A1
(43) Pub. Date: Sep. 24, 2009

(54) COAXIAL PRESSURE RETENTION AND RELIEF MECHANISM

(75) Inventors: Joseph Lubinski, Livonia, MI (US); Patrick Powell, Farmington Hills, MI (US)

Correspondence Address: HARNESS, DICKEY & PIERCE, P.L.C., P.O. BOX 828, BLOOMFIELD HILLS, MI, 48303, US

(73) Assignee: DENSO International America, Inc., Southfield, MI (US)

(21) Appl. No.: 12/352,092

(22) Filed: Jan. 12, 2009

Related U.S. Application Data
(60) Provisional application No. 61/070,205, filed on Mar. 19, 2008.

(51) Int. Cl. F16K 17/04

(52) U.S. Cl. 137/535

(57) ABSTRACT

A pressure relief mechanism may utilize a casing that defines an internal cavity, a fluid inlet, and a fluid outlet. A first valve may reside within the internal cavity to permit fluid flow in one direction and further utilize a first valve carriage and a first valve spring that forces the first valve carriage against a first end of the casing internal cavity, over the fluid inlet. The first valve spring may reside against a second end of the casing cavity. A second valve may reside within the internal cavity and utilize a second valve carriage, a second valve body, and a second valve spring that biases the second valve body against the first valve body, the second valve permitting fluid flow opposite to the flow of the first valve.

### CROSS-REFERENCE TO RELATED APPLICATIONS

This application claims the benefit of U.S. Provisional Application No. 61/070205, filed on Mar. 19, 2008.

### FIELD

The present disclosure relates to a coaxial pressure retention and relief mechanism, which may be used in a vehicle fuel system.

### BACKGROUND

The statements in this section merely provide background information related to the present disclosure and may not constitute prior art. Conventional vehicular fuel systems, such as those installed in automobiles, may employ a “return fuel system” whereby a fuel supply line is utilized to supply fuel to an engine and a fuel return line is utilized to return, hence “return fuel system,” unused fuel to a fuel tank. More modern fuel systems typically employ either a mechanical returnless fuel system (“MRFS”) or an electronic returnless fuel system (“ERFS”). In an ERFS only a fuel supply line from a fuel pump module in a fuel tank to an engine is utilized since the speed of the fuel pump may be varied electronically; therefore, no separate return fuel line from the engine to the fuel tank is necessary. As a result, in an ERFS only the exact volume of fuel required by an engine is delivered to the engine, regardless of the varying degree of the volume of fuel required by the engine. In an MRFS, a fuel supply line from a fuel pump module in the fuel tank to the engine is utilized. However, with an MRFS a pressure regulator is usually required to regulate the pressure and volume of fuel supplied to the engine.

While current returnless fuel systems have generally proven to be satisfactory for their applications, each is associated with its share of limitations. One limitation of current returnless fuel systems is maintaining fuel pressure in as much of the fuel line as possible in order to accomplish engine starting and restarting as quickly as possible with no interruptions of fuel supply to the engine. Another limitation of current returnless fuel systems is maintaining the prime condition of the fuel line to prevent “depriming” of the fuel line. An adequate prime condition will permit an adequate fuel supply to reach the engine during engine starting. Another limitation is maintaining a high flow rate and high fuel system pressure during engine operation and a high fuel system pressure when the engine is off.

In still yet another limitation pertaining to current returnless fuel system is relieving fuel line pressure during periods of “dead soak,” to lessen any adverse effects of excessive pressure buildup in the fuel line. Additionally, concerning pressure related valves, valve placement may not be advantageous for ease of assembly or for best utilizing space along the fuel system route. Additionally, placement of such pressure relief and/or check valves may not be optimally advantageous for maintaining adequate fuel volumes and pressures in the fuel line.

What is needed then is a device that does not suffer from the above limitations. This, in turn, will provide a co-axial pressure relief mechanism capable of installation in a fuel line and capable of relieving pressure in more than one direction.

### SUMMARY

In one example, a pressure relief mechanism may employ an outer valve that may employ an outer valve carriage, an outer valve body, and an outer valve spring that biases the outer valve body against the casing, the outer valve permitting fuel flow in a first direction. An inner valve may employ an inner valve carriage, an inner valve body, and an inner valve spring that biases the inner valve body against the outer valve body, the inner valve permitting fuel flow in a direction opposite to the first direction. The outer valve body may define a cavity and the inner valve may be partially or completely contained within the cavity. The pressure relief mechanism may employ a casing such that the inner valve and the outer valve may be contained within the casing. The outer valve and the inner valve may have centerlines that coincide or are coincident. Furthermore, the pressure relief mechanism may employ a pressure relief valve inlet and a pressure relief valve outlet. The outer valve centerline and the inner valve centerline may coincide with the pressure relief valve inlet and the pressure relief valve outlet. Additionally, a separate and additional side relief valve may be resident in the casing.

In another example, a pressure relief mechanism may utilize a casing that defines an internal cavity, an internal cavity fluid inlet, and an internal cavity fluid outlet. The first valve permits fluid flow in a first direction and may reside within the casing internal cavity and employ a first valve carriage and a first valve spring that forces the first valve carriage against a first end of the casing internal cavity. The first valve spring may reside against a second end of the casing cavity.

A second valve may reside within the internal cavity and employ a second valve carriage, a second valve body, and a second valve spring that biases the second valve body against the first valve body. The second valve may permit fuel flow opposite to the first direction of the first valve. The casing defines a casing centerline, the first valve defines a first valve centerline, and the second valve defines a second valve centerline, and the casing centerline, the first valve centerline and the second valve centerline are coincident. The first valve carriage defines a first valve carriage cavity within which the second valve is disposed. The first valve carriage further entails an inner circumferential structure, and an outer circumferential structure such that the inner circumferential structure is covered by the first valve spring and the outer circumferential structure slidably contacts a wall of the internal cavity of the casing when biased by the first valve spring or the force of fluid pressure entering the casing internal cavity through the internal cavity fluid inlet. The inner circumferential structure and the outer circumferential structure may define a gap therebetween through which fluid may flow from the internal cavity fluid inlet to the internal cavity fluid outlet.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a vehicle depicting a fuel system in phantom;

FIG. 2 is a perspective view of a fuel pump module;

FIG. 3 is a side view of a vehicle fuel tank depicting a representative location of a fuel pump module;

FIG. 4 is a diagram of a vehicle fuel supply system depicting a representative location of a co-axial pressure relief mechanism;

FIG. 5 is an enlarged view of a co-axial pressure relief mechanism in a first position;

FIG. 6 is an enlarged view of a co-axial pressure relief mechanism in a second position;

FIG. 7 is an enlarged view of a co-axial pressure relief mechanism depicting an auxiliary relief valve;

FIG. 8 is an enlarged view of a co-axial pressure relief mechanism in a second position; and

FIG. 9 is an enlarged view of a co-axial pressure relief mechanism in a second position.

### DETAILED DESCRIPTION

The following description is merely exemplary in nature and is not intended to limit the present disclosure, application, or uses. It should be understood that throughout the drawings, corresponding reference numerals indicate like or corresponding parts and features. With reference to FIGS. 1-9, description of a fuel pump module for a returnless fuel system, such as an electronic returnless fuel system (“ERFS”) or a mechanical returnless fuel system (“MRFS”), will be described.

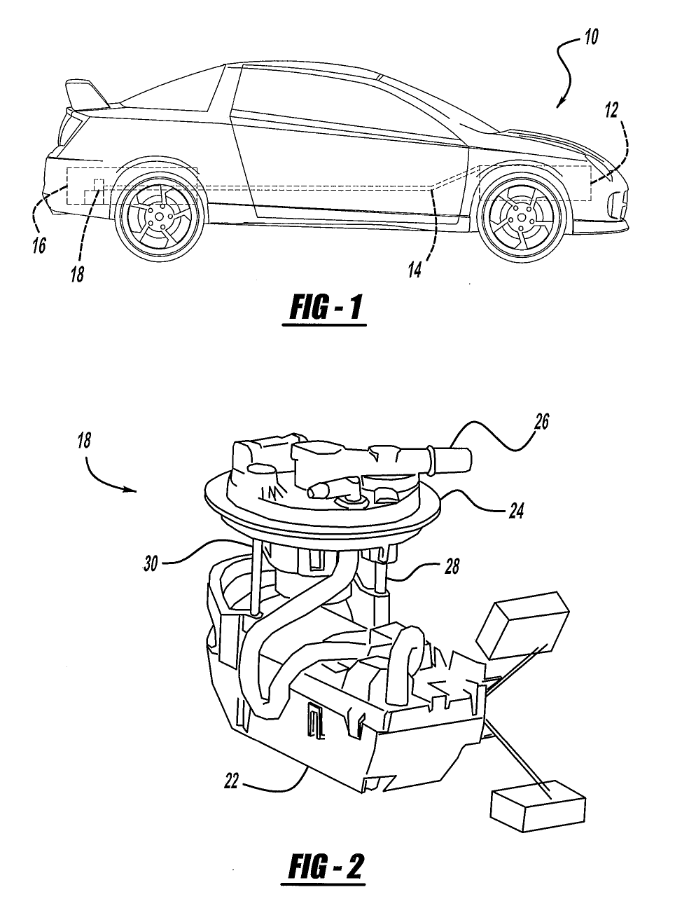

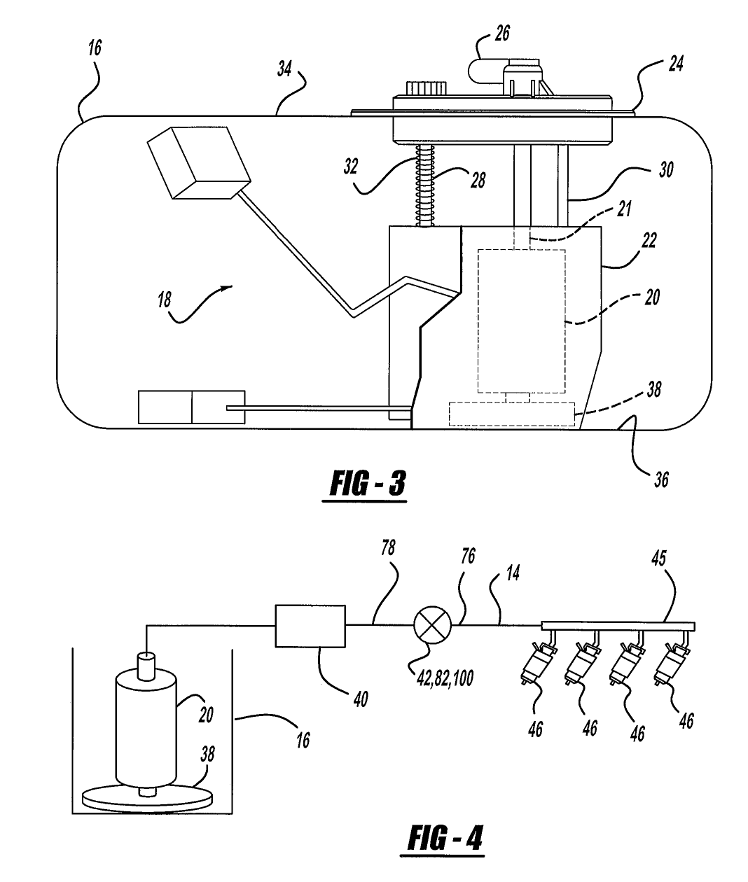

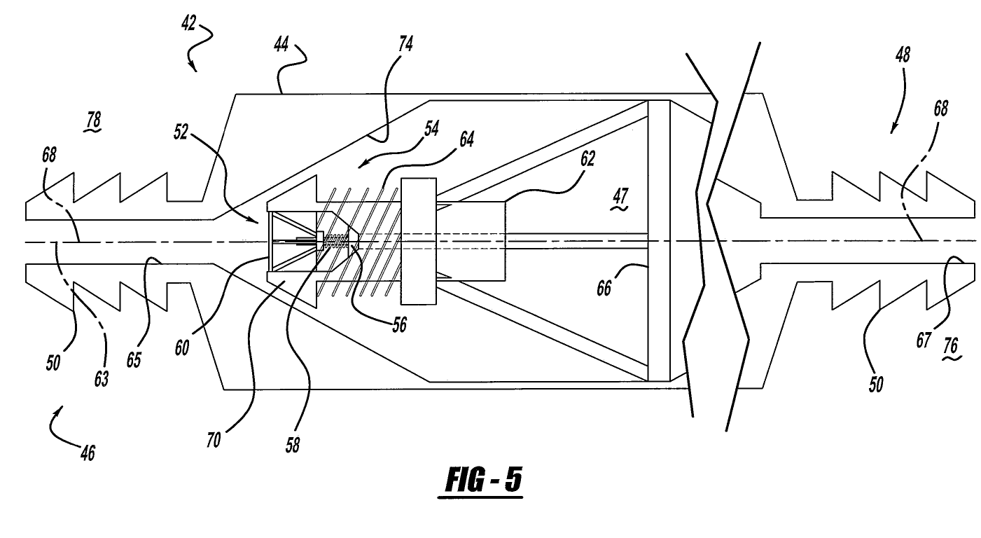

FIG. 1 depicts a vehicle such as an automobile 10 having an engine 12, a fuel supply line 14, a fuel tank 16, and a fuel pump module 18. The fuel pump module 18 fits within the fuel tank 16 and is normally submerged in or surrounded by varying amounts of liquid fuel within the fuel tank 16 when the fuel tank 16 possesses liquid fuel. A fuel pump 20 within the fuel pump module 18 pumps fuel to the engine 12 through the fuel supply line 14. FIG. 2 depicts a representative fuel pump module 18 while FIG. 3 depicts the fuel pump module 18 in its typical environment within the fuel tank 16. Continuing with FIGS. 1-3, the fuel pump module 18 and a portion of its component parts will be presented. Such component parts may consist of a reservoir 22, a fuel pump module flange 24, also known simply as a flange 24, a fuel exit line 26, a first strut 28, a second strut 30, and a spring 32 that surrounds the first strut 28.

When installed and secured within a typical environment of a fuel tank 16, the flange 24 of the module 18 rests upon a top surface 34 of the fuel tank 16. Although the flange 24 ultimately abuts the top surface 34 of the fuel tank 16, the flange 24 must be forced downwardly into the fuel tank 16 during installation of the module 18, in order to sufficiently compress the spring 32, which resides around the first strut 28, to bias the spring 32 and cause the reservoir 22 to be held against the fuel tank floor 36, or bottom interior surface of the fuel tank, by the force of the spring 32. A second strut 30 assists in securing the reservoir 22, and although not depicted, a spring may be secured around the second strut 30 to supply additional securing force to secure the module against the fuel tank floor 36. Upon compression of the spring 32, the flange 24 is secured to the top of the fuel tank 16 by a locking ring (not shown) or similar device. While the flange 24 creates a seal around the periphery of a hole in the top surface of the fuel tank 16, the reservoir 38 is securely held against the bottom floor of the fuel tank 16. FIG. 3 depicts the fuel pump 20 within the reservoir 22 with a fuel filter 38, also called a suction filter 38 or sock filter 38, attached at an end of the fuel pump 20 from which fuel is drawn.

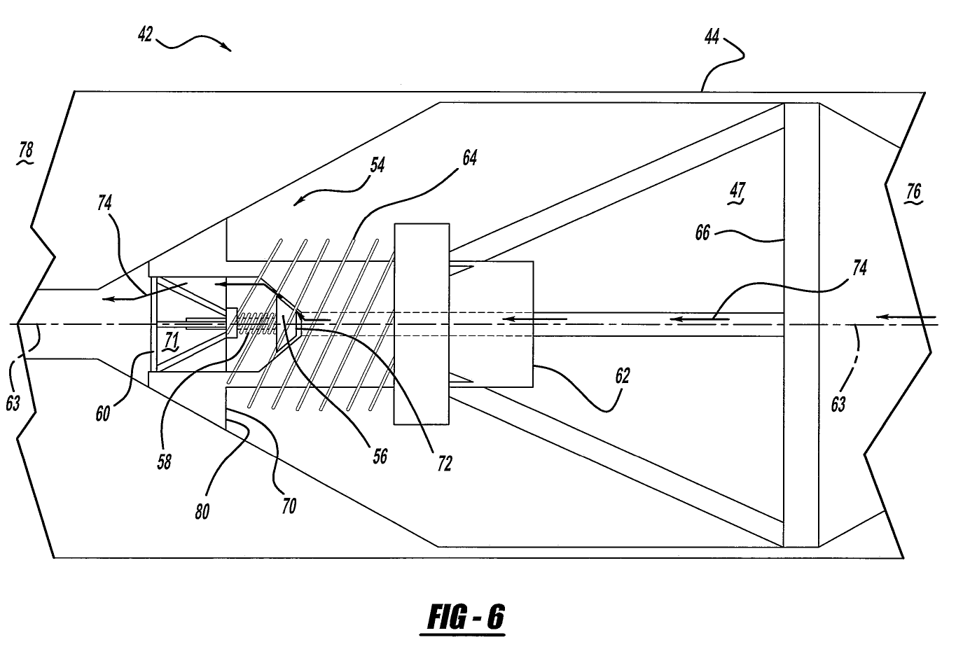

Continuing, FIG. 4 further depicts a fuel filter 40, different from the suction filter 38, a co-axial pressure relief mechanism 42, a fuel rail 45, and fuel injectors 46. FIG. 4 is a schematic representation of a fuel system in which the co-axial pressure relief mechanism 42, which will be explained in further detail later, may be installed. For instance, the fuel filter 40, although depicted away from the fuel pump 20 in FIG. 4, is typically located around the fuel pump 20 in practical use. Nevertheless, FIG. 4 depicts the fuel filter 40 as being in the fuel path, in addition to the suction filter 38, to provide an additional fuel filtering to fuel that is pumped to the common fuel rail 45 and numerous fuel injectors 46 attached to the engine 12. It should be noted that the injection system may also be a port fuel injection system or a direct fuel injection system that utilizes a high pressure pump.

Turning now primarily to FIG. 5, a more detailed explanation of the co-axial pressure relief valve 42 will be provided. FIG. 5 depicts the co-axial pressure relief valve 42, which is enclosed by a casing 44. The casing 44 may be manufactured from a plastic material that is capable of withstanding the operational pressure range of the fuel system and capable of being in contact with liquid fuel, such as gasoline and diesel fuel. Continuing with FIG. 5, the co-axial pressure relief valve 42 has a first end 46 and a second end 48, each equipped with a number of steps or barbs 50 to facilitate the installation of a fuel line, such as a rubber tube, over the barbs 50. In place of barbs 50, other connection systems or methods may be used, such as SAE quick connect connectors. Such a fuel line 14, upon being installed over the barbs 50, may then be further secured with a clamp, such as a hose clamp. Within the casing 44 of the co-axial pressure relief valve 42, is a pair of coaxial valves, an inner valve 52 and an outer valve 54. The inner valve 52 utilizes an inner valve body 56 that is biased with an inner valve spring 58 against an inner valve carriage 60. Continuing, the inner valve body 56, inner valve spring 58 and inner valve carriage 60 all may reside within an outer valve body 62. The outer valve body 62 is biased by an outer valve spring 64 that biases against an outer valve carriage 66.

Continuing with reference to FIGS. 1-5, operation of the co-axial pressure relief mechanism 42 will be explained. Fuel is drawn from the reservoir 22, and through the suction filter 38 by the fuel pump 20 within the fuel pump module 18. The liquid fuel then exits the fuel pump 20 via tube 21 and subsequently the fuel pump module 18 via the fuel exit line 26 on the fuel pump module flange 24. The fuel then flows through the fuel supply line 14 en route to the engine 12. FIG. 5 depicts the flow of liquid fuel 68 into the co-axial pressure relief mechanism 42. As an example, the fuel pump 20 may pump fuel at a variety of pressures, such as 40-95 Kpa, and even from 350-600 Kpa depending upon the application (injection system) and fuel type (such as gasoline or diesel). The pump must be capable of supplying what the engine demands in terms of fuel pressure to properly operate the engine; however, this pressure may vary depending upon the engine and other fuel system requirements. Therefore, the outer valve 54 of co-axial pressure relief valve 42 may be set to open at a pressure of 20 Kpa, which ensures that the outer valve 54 will permit fuel to flow uninterrupted to the engine 12. Regardless of the fuel pressure necessary to operate the engine 12, the outer valve 54 will open at a pressure less than the fuel pressure necessary to operate the engine 12. The outer valve 54 is able to open based upon selection of the outer spring 64. That is, the outer spring 64 may have a spring constant such that the force of the fuel flow 68 is able to bias the outer spring 64 and compress it. Such a configuration will ensure that the engine 12 receives the fuel it needs at the requisite fuel pressure.

As the fuel flow 68 enters the co-axial pressure relief valve 42 the outer spring 64 compresses due to the force of the fuel flow 68 against the outer valve head 70 and the force of the fuel flow 68 against the inner valve head 72 of the inner valve body 56. When the force of the fuel flow 68 strikes the inner valve head 72, it moves the outer valve body 62 to permit the flow of fuel between the outer valve head 70 and the valve casing 44 and through the co-axial pressure relief valve 42 and onward toward the engine 12. As the outer valve body 62 moves (to the right when viewing FIG. 5), it biases against and compresses the outer valve spring 64. No only does the outer valve body 62 move, but the inner valve body 56, inner valve spring 58, and the inner valve carriage 60 translate together with the outer valve body 62. Continuing, the outer valve spring 64 biases against the outer valve carriage 66, which also provides guidance and stability to the outer valve body 62 as it moves, that is, opens to permit the flow of fuel through the casing 44. Thus, when the fuel flow 68 is flowing to the engine 12, that is from left to right when viewing FIG. 5, the fuel pressure is consistent within, and on each side of the co-axial pressure relief valve 42. One explanation as to why the pressure is consistent through the co-axial pressure relief valve 42 is because the fuel flow 68 is permitted to largely flow in a straight line of flow through the casing 44. More specifically, other than the angle formed between the outer valve head 70 and the inside wall 74 upon which the outer valve head 70 contacts, the fuel flow 68 does not change directions, thus resulting in reduced pressure drops or eliminating pressure drops. That is, because the outer valve head 70 is angled and mates with the angled casing inside wall 74, fuel may maintain a largely unaltered fuel path while contact sufficient to form a seal when fuel flow is necessary in the opposite direction (from the engine to the fuel pump module 18, as will be explained.

FIG. 6 depicts a fuel flow scenario such that the fuel flow 74, and associated fuel pressure, flows from the engine side 76 of the co-axial pressure relief mechanism 42 to the fuel pump module side 78. Such a fuel flow 74 is in response to a pressure differential which will now be explained. When an engine 12 is operating, fuel flows in accordance with the description provided above with respect to FIG. 5. Upon turning off or stopping the engine 12, the outer valve 54 will close and more specifically, the outer valve head 70 will be forced against the inside wall 74 of the casing 44, because the pressure on the fuel pump side 78 of the co-axial pressure relief mechanism 42 becomes insufficient to compress the outer valve spring 64. With the engine 12 not operating, the fuel line 14 on the engine side of the co-axial pressure relief mechanism 42 may experience an increase in temperature and thus fuel pressure within the fuel line 14. Such an increase in temperature and fuel pressure on the engine side 76 of the co-axial pressure relief mechanism 42 may occur due to heat from the engine 12 that remains in the engine compartment after the engine is turned off. The temperature and pressure in the fuel line 14 may increase on hot, sunny summer days, such as when the ambient temperature is greater than the fuel line temperature. Such temperature and pressure may result or be further increase if the vehicle 10 is parked on a hot surface, whether or not subjected to direct sunlight, such as a macadam parking lot, from which heat is radiating upwards.

Continuing with FIG. 6, when the pressure on the engine side 76 of the co-axial pressure relief mechanism 42 is 400 Kpa, for example, due to conditions prevalent after stopping the engine as described above, the fuel pressure will rise and be great enough to begin to compress the inner valve spring 58 as the force due to pressure is applied to the inner valve head 72. The inner valve spring 58 biases against the inner valve carriage 60, which is secured to the outer valve body 62. At the same time that the inner valve 52 is being forced open so that fuel flow 74 may pass to the fuel pump side 78 of the co-axial pressure relief mechanism 42, the fuel pressure from the fuel of fuel flow 74 also is forced against the shoulder 80 of the outer valve head 70, which seals the outer valve head 70 against the inside wall of the casing 44. Upon fuel passing from the engine side 76 of the co-axial pressure relief mechanism 42 to the fuel pump module side 78, the excess fuel and pressure will flow back into the fuel tank 16, which is equipped to handle excess fuel vapor, such as through a vapor vent valve and/or a charcoal canister. By relieving the fuel pressure above that at which the inner valve 52 is set, fuel system components on the engine side 76 of the co-axial pressure relief mechanism 42 may be maintained or preserved, that is not subject to damage by excess pressure.

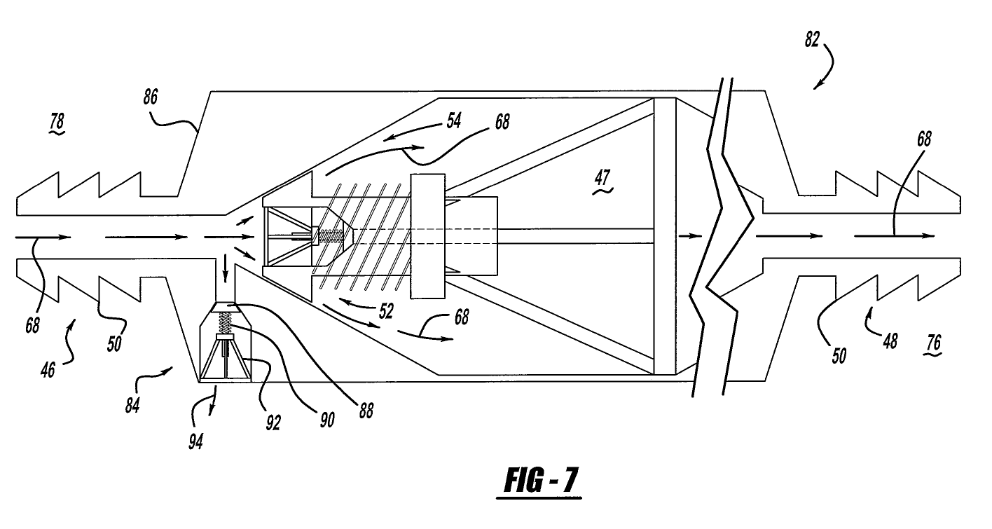

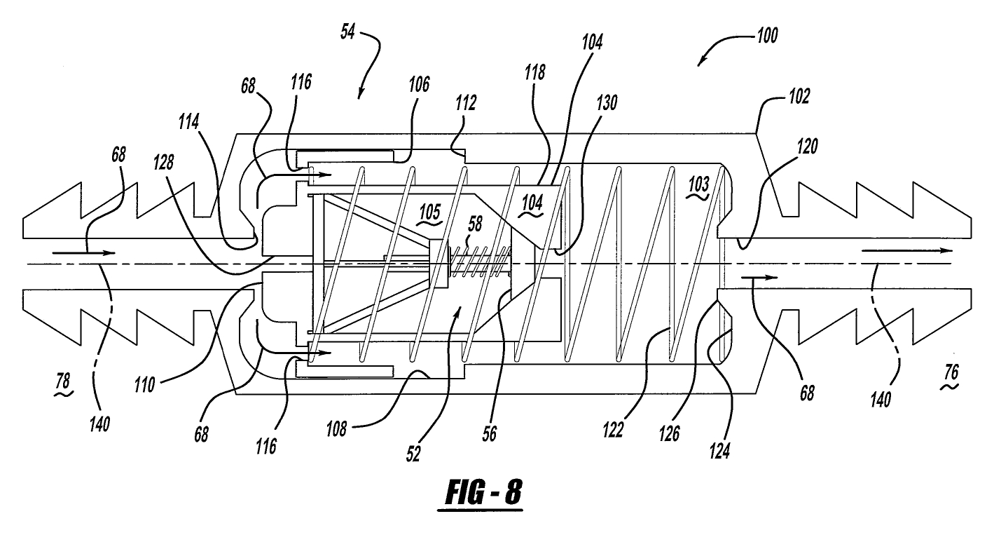

Turning now to FIG. 7, another embodiment of a co-axial pressure relief mechanism 82 will be presented in which a side relief valve 84 is resident in the casing 86. The inner valve 52 and outer valve 54 operate on the same principles as presented in the discussions of FIGS. 5 and 6. The side relief valve 84 may be used to relieve fuel pressure that is above the pressure at which the outer valve 54 operates. That is, during engine operation when the outer valve 54 is open and the outer valve spring 64 is being compressed to permit fuel flow 68 to pass to the engine 12, the side relief valve 84 will normally remain closed. However, if the fuel pump 20 or fuel pumps, in the case of more than one fuel pump, begin to pump fuel at a higher pressure than normally designed, such as in the case of an ERFS that is electronically controlled and not functioning properly, then the side relief valve 84 will open and relief the excess fuel pressure while the engine 12 continues to operate. The side relief valve 84 operates on the same principles as the inner valve 52 and has a valve body 88, a valve spring 90, and a valve carriage 92. When the fuel pressure caused by the fuel flow 68 is able to provide enough force on the valve body 88 to cause compression of the valve spring 90, the valve permits fuel flow 94 to escape from the casing 86. By utilizing the side valve 84 in the casing, fuel system components from the fuel pump 20, or multiple fuel pumps, to the engine, including the fuel rail 45, the fuel injectors 46, the fuel line 14, the co-axial pressure relief mechanism 82, and any component subjected to the fuel pressure created by the fuel flow 68. Thus, the side relief valve 84 relieves fuel pressure caused by the fuel pump 20 or pumps, as the case may be.

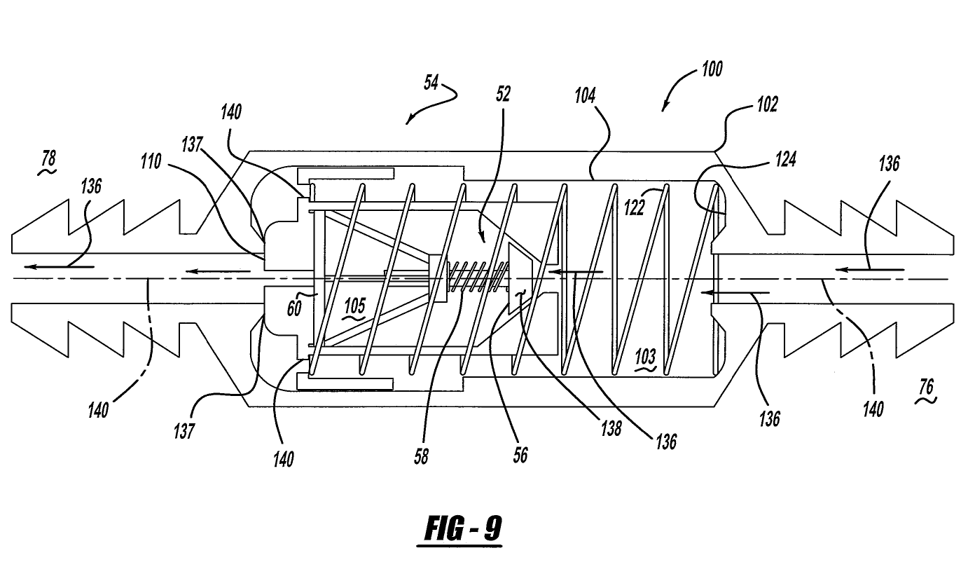

Turning now to FIG. 8, another embodiment of a coaxial pressure relief mechanism 100 will be presented. The coaxial pressure relief mechanism 100 has a casing 102, within which a outer carriage 104 may slide in a longitudinal direction or path. The outer carriage 104 has an outer circumferential structure 106 that makes contact with an interior wall surface 108 of the casing 102. More specifically, the outer circumferential structure 106 slides against the interior wall surface 108 as the fuel flow 68 applies a force against the end face 110 of the outer carriage 104. The outer carriage 104 slides along the interior wall 108 until the end 106 of the outer circumferential structure 106 strikes the wall 112. As the outer circumferential structure 106 begins to slide, from left to right in FIG. 8, and the outer carriage 104 moves away from the inlet orifice 114, the inlet orifice 114 permits the fuel flow 68 to enter the interior of the casing 102 and flow to the outer circumferential structure 106 where it is able to pass through orifices 116 in the outer circumferential structure 106. Upon passing through the orifices 116 of the outer circumferential structure 106, the fuel flow proceeds around an inner circumferential structure 118 of the outer carriage 104 and out through an exit orifice 120 of the casing 102.

Continuing with FIG. 8, as the carriage moves due to the force of the fuel flow 68, the outer valve spring 122 begins to compress against the casing 102 at an interior end 124 opposite that from which the outer carriage 104 originated. The interior end 124 has a protuberance 126 to retain the spring 122 in its interior position longitudinally at one end of the spring, while the other end of the spring resides around the inner circumferential structure 118 of the outer carriage 104 and abuts at the juncture of the inner circumferential structure 118 and the outer circumferential structure 106. Thus the outer valve spring 122 may be adjusted with regards to spring constant to adjust the force at which the outer carriage 104 will begin to move.

Continuing with FIG. 8, and to assist the outer carriage 104 in moving within the casing 102, the outer carriage 104 has an outer carriage inlet orifice 128 or hole and an outer carriage outlet orifice 130 or hole. When the engine is operating and the fuel flow 68 creates a pressure on the fuel pump side 78 of the co-axial pressure relief mechanism 100 that is greater than the pressure on the engine side 76 of the co-axial pressure relief mechanism 100, the fuel flow 68 enters the outer carriage inlet orifice 128 and applies a force against the inner valve body 132, which is the same direction that the inner valve spring 134 exerts a force against the inner valve body, to provide the external force necessary to move the outer carriage 104 against the force of the outer valve spring 122 and thus permit the fuel flow 68 into the casing 102 and flow to the engine 12. In so doing the fuel pressure is regulated by the outer valve spring 122. FIG. 9 depicts a fuel pressure situation that may result when the engine is turned off.

Turning now to FIG. 9, the co-axial pressure relief mechanism 100 depicts a scenario in which the engine 12 is not operating. Further, the fuel 136 in the fuel line 14, may be subject to heat such that the fuel pressure may increase on the engine side 76 of the co-axial pressure relief mechanism 100. To begin, when the engine 12 is turned off, the fuel pump 20 stops pumping fuel to the engine 12 and the force of flowing fuel that normally biases the outer spring 122 and the outer carriage 104 against the interior end 124 of the casing 102 no longer exists. As a result, the outer valve spring 122 may bias the end face 110 of the outer carriage 104 against the interior surface 137 of the casing 102 to preserve the fuel pressure in the engine side 76 of the fuel line 14. By preserving the fuel pressure on the engine side 76 of the fuel line 14, the fuel pump 20 does not have to re-generate or re-create such pressure before re-starting the engine. Desirably, as a result, the engine 12 will re-start faster. However, by essentially making the engine side 76 of the fuel line 14 a closed vessel when the outer valve 54 closes (the face 110 against interior surface 137), the fuel pressure may further increase on the engine side 76 and at a particular pressure, damage to fuel injectors 46, a common rail 45, the fuel line 14, or other connections, such as the connections that secure the co-axial pressure relief mechanism 100 to the fuel line 14 may result.

Continuing with FIG. 9, to relieve pressure in the engine side 76 fuel line with the outer valve 54 in a closed position, as depicted in FIG. 9, the inner valve 52 will open. The inner valve 52, in part, utilizes an inner valve carriage 60, an inner valve spring 58, and an inner valve body 56 that work in conjunction with the outer valve carriage 104. More specifically, when the resulting force of the fuel pressure in the engine side 76 of the fuel line 14 against the head 138 is greater than the opposing force of the inner valve spring 58, which counters the force due to the fuel pressure, the head 138 lifts or separates from the interior surface of the outer carriage 104 to permit the relief of pressure and fuel flow 136 through the inner valve 52. As a result, the fuel flow passes from the engine side 76 of the co-axial pressure relief mechanism 100 to the fuel pump side 78 of the co-axial pressure relief mechanism 100, thus maintaining pressure in the engine side 76 that is a desirable re-starting pressure, yet relieving pressure over such desirable re-starting pressure. Such relieved pressure passes through the fuel line 14 and into the fuel tank 16, where one of more vapor vent valves may process such vapor pressure.

There are multiple advantages to the present disclosure, such as maintaining some degree of fuel pressure in the fuel line 14 on the engine side 76 of the co-axial pressure relief mechanism 42 to more quickly start the engine 12 when a user desires. If fuel pressure was not maintained in the engine side 76 of the fuel line 14, time to fill and/or pressurize the line would be necessary. Such time would be undesirable for a vehicle operator. Thus use of the co-axial pressure relief mechanism 42 permits pressure to remain on the engine side 76 of the fuel line 14 yet relieve excess pressure that may otherwise damage fuel system components on the engine side 76 of the co-axial pressure relief mechanism 42, such as fuel line 14 itself, the fuel rail 45 and/or fuel injectors 46.

There are additional advantages of the co-axial pressure relief mechanism 42 as described in the present disclosure. First, the co-axial pressure relief mechanism 42 will permit the use of one, two or more fuel pumps without requiring the fuel pumps to have an internal check valve. This will result in a cost savings to each fuel pump since an internal check valve is not necessary. Additionally, by not requiring an internal check valve, there is a reduced possibility of part failure. Second, the co-axial pressure relief mechanism 42 will permit the jet pumps on the fuel pump module to operate using high pressure filtered fuel for better fuel delivery module performance. That is, the jet pumps will not interfere with the pressurized fuel flowing to the engine during engine on or engine off conditions. Third, the co-axial pressure relief mechanism 42 is optimizes fuel pressure losses throughout the fuel system thereby promoting longevity of the fuel pump(s) and the fuel pump module. Pressure losses are optimized because the direction of fuel through the co-axial design is permitted to flow largely in a straight line flow, as opposed to changing directions, as in non-co-axial valves.

Continuing with advantages of the teachings of the present disclosure, fourth, the co-axial pressure relief mechanism 42 can be easily implemented into an MRFS fuel system with minimal modifications to meet demands of customers with ERFS requirements. Fifth, the co-axial pressure relief mechanism 42 may be implemented into vehicles with ERFS and MRFS because the co-axial pressure relief mechanism 42 is an inline device, is relatively small in cross-section, and does not need to be installed within a fuel pump module itself, thereby eliminating fuel pump module modifications related to such a valve 42. Sixth, the co-axial pressure relief mechanism 42 permits the elimination of a traditional pressure regulator, normally associated with an MRFS, because the co-axial pressure relief mechanism 42 has the ability to relieve fuel pressure at a specific set pressure. The elimination of a pressure regulator in the fuel pump module also results in a cost reduction and elimination of a potential failure point within a fuel pump module. Seventh, with the use of the co-axial pressure relief mechanism 42 the overall complexity of a fuel pump module in an MRFS (elimination of check valve on the pump and elimination of a pressure regulator) and in an ERFS (elimination of a check valve on the fuel pump) is reduced. Eighth, the co-axial pressure relief mechanism 42 maintains high pressure fuel in the fuel line during fuel pump and engine operation, while allowing the high pressure fuel to be relieved when the engine is off. Such relief may be from a secondary valve installed between the co-axial pressure relief mechanism 42 and the fuel pump module 18, and in one example, actually in the co-axial pressure relief mechanism 42 casing. Furthermore, because the co-axial pressure relief mechanism is of a co-axial design, as opposed to parallel or side-by-side designs, the pressure drop caused by the mechanism is minimal.

So, further to what is disclosed above, a pressure relief mechanism 42 may employ or be comprised of an outer valve 54 having an outer valve body 62. The outer valve 54 relieves pressure in a first direction, and an inner valve 52, having an inner valve body 56, relieves pressure in a second direction. The inner valve 52 may be completely or fully contained within the outer valve body 62. The pressure relief mechanism 42 may further comprise an outer valve centerline 63, and an inner valve centerline 63. That is, the outer valve centerline 63 and the inner valve centerline 63 coincide or are coincident. The pressure relief mechanism 42 may further comprise a pressure relief valve inlet 65, and a pressure relief valve outlet 67. The outer valve centerline 63 and the inner valve centerline 63 are concentric with the pressure relief valve inlet 65 and the pressure relief valve outlet 67. The pressure relief mechanism 42 may further comprise a casing 44, which may be one or more pieces, and the first valve 54 and the second valve 52 reside within the casing 44. The pressure relief mechanism 42 may further operate such that wherein fuel entering from the pressure relief valve inlet 65 is directed to force open the outer valve 54 and force closed the inner valve 52 closed and fuel entering from the pressure relief valve outlet 67 is directed to force open the inner valve 52 and force closed the outer valve 54.

In another example, a pressure relief mechanism 42 may employ an inner valve 52 and an outer valve 54. The outer valve 54 may comprise an outer valve carriage 66, an outer valve body 62, and an outer valve spring 64 that biases the outer valve body 62 against the casing 44. The outer valve 54 permit fuel flow in a first direction (FIG. 5) when fluid or fuel pressure is great enough to bias the outer valve spring 64 and mover the outer valve head 70 from the inside wall 74. The inner valve 52 may comprise an inner valve carriage 60, an inner valve body 56, and an inner valve spring 58 that biases the inner valve body 56 against the outer valve body 62. In accordance with FIG. 6, the inner valve 52 permits fluid or fuel flow in a direction opposite to the first direction. More specifically, when the fuel pressure in the fuel line 14 on the engine side 76 of the valve 42 rises after the engine 12 is turned off, the inner valve 52 will open by compressing the inner valve spring 58 and relieving pressure above which the inner valve spring 58 compresses.

Continuing with FIG. 6, the outer valve body 62 defines an outer valve body cavity 71 and the inner valve 52 is contained within the outer valve body cavity 71. The pressure relief mechanism 42 may further comprise a casing 44 and the inner valve 52 and the outer valve 54 are contained within the casing 44. The pressure relief mechanism 42 may further possess or have an outer valve centerline 63 and an inner valve centerline 63 such that the outer valve centerline 63 and the inner valve centerline 63 coincide.

The pressure relief mechanism 42 may further comprise a pressure relief valve inlet 65 and a pressure relief valve outlet 67. The outer valve centerline 63 and the inner valve centerline 63 coincide with the pressure relief valve inlet 65 and the pressure relief valve outlet 67. The pressure relief mechanism 42 may further possess a side relief valve 84 resident in the casing 44. The side relief valve 84 contains a valve body 88, a valve spring 90, and a valve carriage 92. Fuel flow 94 may exit from the side relief valve 84 when the force of the fuel pressure in the fuel line 14 on the fuel pump side of the pressure relief mechanism 42 causes the valve spring 90 to compress.

FIGS. 8 and 9 depict a pressure relief mechanism 100 that may further employ a casing 102 that defines an internal cavity 103 with the first valve 54 residing within the internal cavity 103. The second valve 52 may also reside within the internal cavity 103. The first valve 54 may further comprise a first valve carriage 104 and a first valve spring 122 that biases the first valve carriage 104 against a first end of the cavity 103. The first valve spring 122 may reside against a second end 124 of the cavity 103. A fluid inlet 114 into the cavity 103 may exist at the first end of the cavity 103 and a fluid outlet 120 from the cavity 103 may exist at a second end of the cavity 103. The fluid entering from the fluid inlet 114 causes the first valve carriage 104 to move and compress the first valve spring 122 and permit passage of fluid 68 through the internal cavity 103.

Continuing with FIGS. 8 and 9, the pressure relief mechanism 100 may further be arranged or designed so that the first valve carriage 104 defines a first valve internal cavity 105 with a fluid inlet 128. Additionally, the pressure relief mechanism 100 may further employ a second valve 52 residing within the first valve internal cavity 105. The second valve 52 may employ a second valve carriage 60. The second valve body 56 may be disposed in, or pass through, the second valve carriage 60. A second valve spring 58 biases the second valve body 56 against the fluid inlet 130 of the first valve internal cavity 105.

The pressure relief mechanism 100 may further be designed such that the first valve carriage 104 further defines a fluid outlet 128 to disperse fluid pressure from the first valve internal cavity 105. The first valve carriage 104 slides within the internal cavity 103 of the casing 102. The first valve carriage 104 may further employ an inner circumferential structure 118, and an outer circumferential structure 106. The inner circumferential structure 118 is covered by the first valve spring 122 and the outer circumferential structure 106 slidably contacts a wall 112 of the internal cavity 103 of the casing 102. The inner circumferential structure 118 and the outer circumferential structure 106 define a gap 140 therebetween through which fluid 68 may flow from a mechanism inlet 114 to a mechanism outlet 120.

With continued reference to FIG. 8, a pressure relief mechanism 100 may employ a casing 102 that defines a casing internal cavity 103, an internal cavity fluid inlet 114, and an internal cavity fluid outlet 120. Additionally, a first valve 54 may reside within the casing internal cavity 103. The first valve 54 may further comprise a first valve carriage 104, and a first valve spring 122 that forces the first valve carriage 104 against a first end of the casing internal cavity 103. The first valve spring 122 may reside against a second end 124 of the casing cavity 103. The first valve 54 may permit fuel flow 68 in a first direction, that is, to the right when viewing FIG. 8.

A second valve 52 may reside within the internal cavity 103 and employ a second valve carriage 60, a second valve body 56, and a second valve spring 58 that biases the second valve body 56 against the first valve body 104. The second valve 52 permits fuel flow 136 opposite to the first direction. The first fuel flow 68 is to the right in FIG. 8 while the opposite fuel flow 136 is to the left in FIG. 9. The pressure relief mechanism 100 may be designed so that the casing 102 defines a casing centerline 140. Additionally, the first valve 54 defines a first valve centerline 140 while the second valve 52 defines a second valve centerline 140. The casing centerline 140, the first valve centerline 140 and the second valve centerline 140 are coincident.

The pressure relief mechanism 100 may be designed in a way that the first valve carriage 104 defines a first valve carriage cavity 105 within which the second valve is disposed. The pressure relief mechanism 100 may be designed such that the first valve carriage 54 may further employ an inner circumferential structure 118 and an outer circumferential structure 106. The inner circumferential structure 118 is covered or wrapped by the first valve spring 122. The outer circumferential structure 106 slidably contacts a wall or a wall surface 108, 112 of the internal cavity 103 of the casing 102. The pressure relief mechanism 100 may be designed such that the inner circumferential structure and the outer circumferential structure 106 define a gap therebetween through which fluid 68 may flow from the internal cavity fluid inlet 114 to the internal cavity fluid outlet 120.

What is claimed is:

1. A pressure relief mechanism comprising:
an outer valve having an outer valve body, the outer valve to relieve pressure in a first direction; and
an inner valve having an inner valve body, the inner valve to relieve pressure in a second direction, wherein the inner valve is contained within the outer valve body.

2. The pressure relief mechanism of claim 1, further comprising:
an outer valve centerline; and
an inner valve centerline, wherein the outer valve centerline and the inner valve centerline coincide.

3. The pressure relief mechanism of claim 2, further comprising:
a pressure relief valve inlet; and
a pressure relief valve outlet, wherein the outer valve centerline and the inner valve centerline are concentric with the pressure relief valve inlet and the pressure relief valve outlet.

4. The pressure relief mechanism of claim 1, further comprising:
a casing, wherein the first valve and the second valve reside within the casing.

5. The pressure relief mechanism of claim 1, wherein fuel entering from the pressure relief valve inlet is directed to force the outer valve open and the inner valve closed and fuel entering from the pressure relief valve outlet is directed to force the inner valve open and the outer valve closed.

6. A pressure relief mechanism comprising:
an outer valve comprising:
an outer valve carriage;
an outer valve body; and
an outer valve spring that biases the outer valve body against the casing, the outer valve permitting fuel flow in a first direction; and
an inner valve comprising:
an inner valve carriage;
an inner valve body; and
an inner valve spring that biases the inner valve body against the outer valve body, the inner valve permitting fuel flow in a direction opposite to the first direction.

7. The pressure relief mechanism according to claim 6, wherein the outer valve body defines a cavity and the inner valve is contained within the cavity.

8. The pressure relief mechanism according to claim 7, further comprising:
a casing, wherein the inner valve and the outer valve are contained within the casing.

9. The pressure relief mechanism of claim 8, further comprising:
an outer valve centerline; and
an inner valve centerline, wherein the outer valve centerline and the inner valve centerline coincide.

10. The pressure relief mechanism of claim 9, further comprising:
a pressure relief valve inlet; and
a pressure relief valve outlet, wherein the outer valve centerline and the inner valve centerline coincide with the pressure relief valve inlet and the pressure relief valve outlet.

11. The pressure relief mechanism of claim 10, further comprising:
a side relief valve, the side relief valve resident in the casing.

12. A pressure relief mechanism comprising:
a casing defining an internal cavity;
a first valve residing within the internal cavity, the first valve comprising:
a first valve carriage; and
a first valve spring that biases the first valve carriage against a first end of the cavity, the first valve spring residing against a second end of the cavity;
a fluid inlet into the cavity at the first end of the cavity; and
a fluid outlet from the cavity at a second end of the cavity, wherein fluid entering from the fluid inlet causes the first valve carriage to move and compress the first valve spring and permit passage of fluid through the internal cavity.

13. The pressure relief mechanism of claim 12, wherein the first valve carriage defines a first valve internal cavity with a fluid inlet, the pressure relief mechanism further comprising:
a second valve residing within the first valve internal cavity, the second valve further comprising:
a second valve carriage;
a second valve body disposed in the second valve carriage; and
a second valve spring that biases the second valve body against the fluid inlet of the first valve internal cavity.

14. The pressure relief mechanism of claim 13, wherein the first valve carriage further defines a fluid outlet to disperse fluid pressure from the first valve internal cavity.

15. The pressure relief mechanism of claim 14, wherein the first valve carriage slides within the internal cavity of the casing.

16. The pressure relief mechanism of claim 12, wherein the first valve carriage further comprises:
an inner circumferential structure; and
an outer circumferential structure, wherein the inner circumferential structure is covered by the first valve spring and the outer circumferential structure slidably contacts a wall of the internal cavity of the casing.

17. The pressure relief mechanism of claim 16, wherein the inner circumferential structure and the outer circumferential structure define a gap therebetween through which fluid may flow from a mechanism inlet to a mechanism outlet.

18. A pressure relief mechanism comprising:
a casing that defines a casing internal cavity, an internal cavity fluid inlet, and an internal cavity fluid outlet;
a first valve residing within the casing internal cavity, the first valve comprising:
a first valve carriage; and
a first valve spring that forces the first valve carriage against a first end of the casing internal cavity, the first valve spring residing against a second end of the casing cavity, the first valve permitting fuel flow in a first direction;
a second valve residing within the internal cavity, the second valve comprising:
a second valve carriage;
a second valve body; and
a second valve spring that biases the second valve body against the first valve body, the second valve permitting fuel flow opposite to the first direction.

19. The pressure relief mechanism of claim 18, wherein the casing defines a casing centerline, the first valve defines a first valve centerline, and the second valve defines a second valve centerline, and the casing centerline, the first valve centerline and the second valve centerline are coincident.

20. The pressure relief mechanism of claim 19, wherein the first valve carriage defines a first valve carriage cavity within which the second valve is disposed.

21. The pressure relief mechanism of claim 20, wherein the first valve carriage further comprises:
an inner circumferential structure; and
an outer circumferential structure, wherein the inner circumferential structure is covered by the first valve spring and the outer circumferential structure slidably contacts a wall of the internal cavity of the casing.

22. The pressure relief mechanism of claim 21, wherein the inner circumferential structure and the outer circumferential structure define a gap therebetween through which fluid may flow from the internal cavity fluid inlet to the internal cavity fluid outlet.
